(19) United States
(12) Patent Application Publication
(10) Pub. No.: US 2012/0257762 A1
(43) Pub. Date: Oct. 11, 2012

(54) COMMUNICATION SYSTEM, RECEIVING APPARATUS AND COMMUNICATION METHOD

(75) Inventors: Yuji Kawasaki, Fukuoka (JP); Keiji Yamahai, Fukuoka (JP); Akira Suzuki, Fukuoka (JP)

(73) Assignee: PANASONIC CORPORATION, Osaka (JP)

(21) Appl. No.: 13/516,408

(22) PCT Filed: Nov. 2, 2011
(86) PCT No.: PCT/JP2011/006152

§ 371 Date: Jun. 15, 2012

(30) Foreign Application Priority Data
Nov. 18, 2010 (JP) 2010-257556

(51) Int. Cl. G10K 11/16

(52) U.S. Cl. 381/71.1

(57) ABSTRACT

The present invention provides a communication system. When the audio signal in the wide band is input to a wireless microphone, the wireless microphone performs a balanced modulation processing to invert the frequency spectrum of the audio signal and transmits the audio signal with the inverted frequency. When a speaker apparatus receives the audio signal transmitted from the wireless microphone, the speaker apparatus cuts off a frequency component of the received audio signal in the frequency band of the infrared radiation noise produced by the external apparatus (infrared radiation noise band), performs a reverse balanced modulation processing to invert again the frequency spectrum of the audio signal having the frequency component in the infrared radiation noise band cut off, and outputs the audio signal with the frequency spectrum inverted again.

### RELATED APPLICATION

This application claims the benefits related to Japanese Patent Application No. 2010-257556 filed in Japan on Nov. 18, 2010 and the contents of the application are to be incorporated herein by reference.

### TECHNICAL FIELD

The present invention relates to a communication system that transmits and receives an audio signal in a wide band and in particular to a technique of removing infrared radiation noise from the outside of the communication system.

### BACKGROUND ART

A typical conventional communication system incorporating an infrared microphone uses infrared radiation to transmit a voice signal between a wireless microphone and a speaker apparatus (in a main voice band of 300 Hz to 3 kHz).

Therefore, if there is an apparatus that produces infrared radiation noise in the transmission space of the infrared radiation, such as the room in which the wireless microphone and the speaker apparatus are used, the voice signal transmitted from the microphone to the speaker apparatus is affected by the infrared radiation noise.

For example, a plasma display panel (PDP) of a television set emits, from the screen, not only the visible light but also a vast amount of infrared radiation noise (in a main noise band of several hundred Hz). If the infrared microphone system used in the same space as the PDP has a light sensitivity in the infrared radiation noise band, the wireless microphone cannot be used because of the excessive noise output from the PDP.

To solve the problem, there has been proposed an optical signal transmitting system that removes noise by using eight-to-fourteen modulation (EFM) and a high-pass filter (see Japanese Patent Laid-Open No. 4-348627). In the conventional optical signal transmitting system, the transmitting apparatus uses EFM to shift the voice signal to be transmitted into a safe band in which the voice signal is less likely to be affected by the noise (to a higher frequency band than the voice signal to be transmitted) before transmitting the voice signal, and the receiving apparatus having received the voice signal (EFM-modulated signal) removes the noise by the high-pass filter cutting off the noise component (a lower frequency component).

However, in order to use EFM, the conventional optical signal transmitting system has to reserve the band into which the voice signal to be transmitted is shifted (which is almost twice as wide as the band of the audio signal). When such a conventional system transmits an audio signal in a wide band including the audio band (100 Hz to 15 kHz), it is difficult to ensure the band into which the audio signal is shifted (which is almost twice as wide as the wide band of the audio signal).

### SUMMARY OF INVENTION

An object of the present invention is to provide a communication system for transmitting and receiving an audio signal in a wide band that can appropriately remove infrared radiation noise from the outside of the communication system.

The present invention provides a communication system comprising: a transmitting apparatus that transmits an audio signal in a wide band including a frequency band higher than a voice band; and a receiving apparatus that receives the audio signal from the transmitting apparatus. The transmitting apparatus comprises: an audio input portion to which the audio signal in the wide band is input; a balanced modulation portion that inverts a frequency spectrum of the audio signal input to the audio input portion; and a transmitting portion that transmits the audio signal having the frequency spectrum inverted by the balanced modulation portion. The receiving apparatus comprises: a receiving portion that receives the audio signal transmitted from the transmitting apparatus; a filter portion that cuts off a frequency component in a frequency band of infrared radiation noise (referred to as an “infrared radiation noise band” hereinafter) of the audio signal received by the receiving portion; a reverse balanced modulation portion that inverts again the frequency spectrum of the audio signal having the frequency component in the infrared radiation noise band cut off by the filter portion; and an audio output portion that outputs the audio signal having the frequency spectrum inverted again by the reverse balanced modulation portion.

In addition, the present invention provides a communication method performed in a communication system comprising a transmitting apparatus that transmits an audio signal in a wide band including a frequency band higher than an voice band and a receiving apparatus that receives the audio signal from the transmitting apparatus. In the communication method, the transmitting apparatus first inverts a frequency spectrum of the input audio signal, and transmits the audio signal having the frequency spectrum inverted to the receiving apparatus. Then, the receiving apparatus receives the audio signal transmitted from the transmitting apparatus, cuts off a frequency component in the infrared radiation noise band of the received audio signal, inverts again the frequency spectrum of the audio signal having the frequency component in the infrared radiation noise band cut off, and outputs the audio signal having the frequency spectrum inverted again.

As described below, the present invention has other aspects. Therefore, this disclosure of the present invention is intended to provide a portion of the present invention but is not intended to limit the scope of the present invention described and claimed herein.

### BRIEF DESCRIPTION OF DRAWINGS

FIG. 1 is a block diagram showing a configuration of a communication system according to a first embodiment of the present invention.

FIG. 2 includes diagrams for illustrating an operation of a transmitting apparatus (wireless microphone) according to the first embodiment of the present invention.

FIG. 3 includes diagrams for illustrating an operation of a receiving apparatus (speaker apparatus) according to the first embodiment of the present invention.

FIG. 4 is a block diagram showing a configuration of a communication system according to a second embodiment of the present invention.

### DESCRIPTION OF EMBODIMENTS

In the following, the present invention will be described in detail. Embodiments described below are only examples of the present invention, and a wide variety of modifications can be made thereto. Therefore, the specific configurations and functions disclosed in the following description do not limit the scope of the present invention defined in the claims.

In the following, communication systems according to embodiments of the present invention will be described in detail with reference to the drawings. In the following embodiments, communication systems used for microphone systems of the infrared communication type will be described.

### First Embodiment

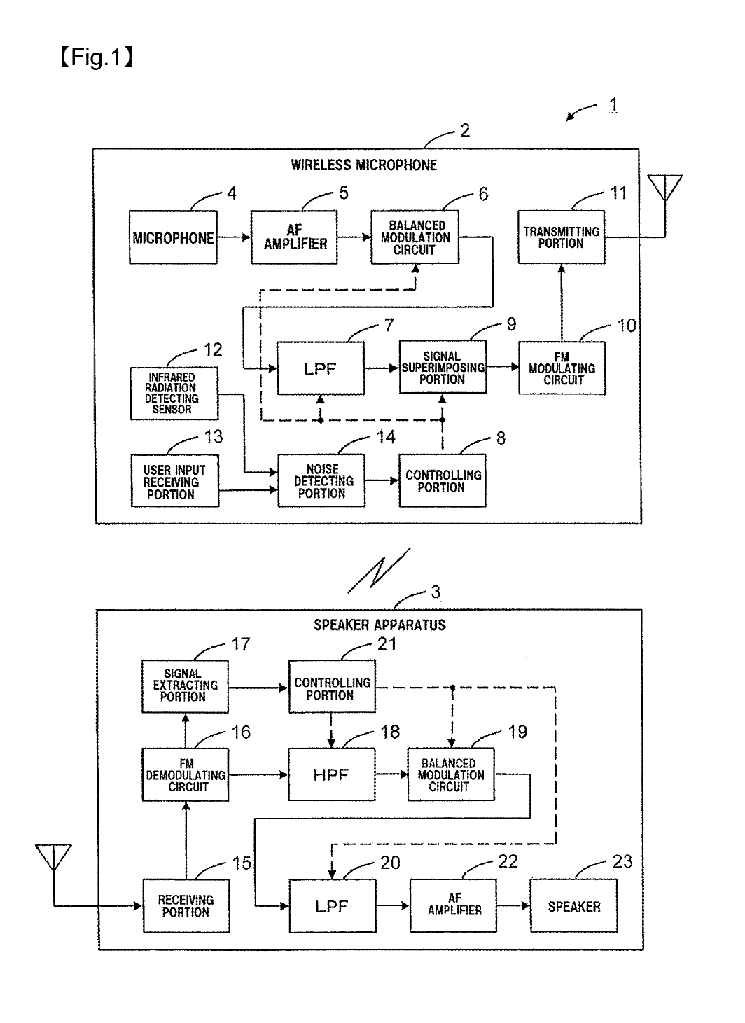

A configuration of a communication system according to a first embodiment of the present invention will be described in detail with reference to the drawings. FIG. 1 is a block diagram showing the configuration of the communication system according to this embodiment. As shown in FIG. 1, a communication system 1 includes a wireless microphone 2 serving as a transmitting apparatus and a speaker apparatus 3 serving as a receiving apparatus. In the communication system 1, an audio signal in a wide band (an audio band from 100 Hz to 15 kHz) is transmitted and received.

The wireless microphone 2 has a microphone 4 to which an audio signal is input, an AF amplifier 5 that amplifies the input audio signal, a balanced modulation circuit 6 that performs a processing of inverting the frequency spectrum of the audio signal (balanced modulation processing (spectral rotation)), a low-pass filter (LPF) 7 that cuts off components at frequencies higher than a modulation clock frequency in the balanced modulation processing, a controlling portion 8 that controls switching of the operations (on/off) of the balanced modulation circuit 6 and the low-pass filter 7, a signal superimposing portion 9 that superimposes a noise detection signal on the audio signal output from the low-pass filter 7, an FM modulating circuit 10 that FM-modulates the audio signal, and a transmitting portion 11 that transmits the audio signal from an antenna.

The wireless microphone 2 further has an infrared radiation detecting sensor 12 that detects infrared radiation from an external apparatus such as a plasma display panel (PDP) of a television set, a user input receiving portion 13 that receives a user input that indicates that there is an external apparatus (such as a PDP) that produces infrared radiation placed nearby, and a noise detecting portion 14 that detects that infrared radiation noise has occurred based on the detection result from the infrared radiation detecting sensor 12 or the user input from the user input receiving portion 13. For example, the noise detecting portion 14 detects that infrared radiation noise has occurred in a case where the level of the infrared radiation detected by the infrared radiation detecting sensor 12 is equal to or higher than a predetermined threshold level or where a dedicated switch is turned on by a user operating the user input receiving portion 13.

The controlling portion 8 controls the balanced modulation circuit 6 to perform the balanced modulation processing when the infrared radiation noise is detected as described above, for example. In addition, the controlling portion 8 controls the signal superimposing portion 9 to superimpose a signal (noise detection signal) that indicates the occurrence of the infrared radiation noise onto the audio signal when the infrared radiation noise is detected as described above, for example. The noise detection signal may be a tone signal.

The tone signal can be used to indicate the occurrence of the infrared radiation noise in the manners described below. First, whether the infrared radiation noise has occurred or not can be indicated by the frequency of the tone signal. For example, a tone signal at a frequency of 30 kHz is used when the infrared radiation noise is detected, and a tone signal at a frequency of 70 Hz is used when no infrared radiation noise is detected. This method is referred to as frequency shift keying (FSK). Alternatively, the frequencies of the tone signals transmitted may be a frequency of 60 Hz to 80 Hz and a frequency of 15 kHz to 90 kHz.

Alternatively, the occurrence of the infrared radiation noise may be indicated by the level or phase of the tone signal superimposed on the audio signal or the presence or absence of the tone signal superimposed on the audio signal. As the modulation method that involves imparting a level or phase to the tone signal, amplitude shift keying (ASK), phase shift keying (PSK), quadrature amplitude modulation (QAM), AM, PM or FM may be used.

On the other hand, the speaker apparatus 3 has a receiving portion 15 that receives the audio signal at an antenna, an FM demodulating circuit 16 that FM-demodulates the received audio signal, a signal extracting portion 17 that extracts the noise detection signal from the FM-demodulated signal, a high-pass filter (HPF) 18 that cuts off components at frequencies equal to or lower than a predetermined frequency (3 kHz, for example), a balanced modulation circuit 19 that performs a processing of inverting the frequency spectrum of the audio signal (balanced modulation processing), a low-pass filter (LPF) 20 that cuts off components at frequencies higher than a modulation clock frequency in the balanced modulation processing, a controlling portion 21 that controls switching of the operations (on/off) of the high-pass filter 18, the balanced modulation circuit 19 and the low-pass filter 20, an AF amplifier 22 that amplifies the audio signal, and a speaker 23 that outputs the audio signal.

The balanced modulation processing (spectral rotation) performed by the balanced modulation circuit 19 in the speaker apparatus 3 is to invert again the frequency of the audio signal with the frequency spectrum having already been inverted (that is, the audio signal with the frequency spectrum having been inverted by the balanced modulation circuit 6 in the wireless microphone 2). Therefore, the balanced modulation processing performed by the balanced modulation circuit 19 in the speaker apparatus 3 can be referred to also as a reverse balanced modulation processing (reverse-spectral rotation), and the balanced modulation circuit 19 in the speaker apparatus 3 can be referred to also as a reserve balanced modulation circuit.

Based on the noise detection signal extracted by the signal extracting portion 17, the controlling portion 21 controls switching of the operations (on/off) of the high-pass filter 18, the balanced modulation circuit 19 and the low-pass filter 20. More specifically, the signal extracting portion 17 extracts the tone signal superimposed on the audio signal in the wireless microphone 2 to determine whether or not the infrared radiation noise is detected on the side of the wireless microphone 2, and outputs the detection result indicated by the noise detection signal to the controlling portion 21. If the infrared radiation noise has occurred, the controlling portion 21 controls the high-pass filter 18 to cut off the components at the frequencies equal to or lower than the predetermined frequency (3 kHz, for example). In addition, if the infrared radiation noise has occurred (or if infrared radiation noise equal to or higher than a predetermined threshold has been detected), the controlling portion 21 controls the balanced modulation circuit 19 to perform the balanced modulation processing. Although the predetermined frequency (cut-off frequency of the high-pass filter 18) is 3 kHz in the example described above, the cut-off frequency of the high-pass filter 18 is, of course, not limited to the value.

An operation of the communication system 1 configured as described above will be described with reference to the drawings. In the following, a case will be described where an external apparatus (such as a PDP) that produces infrared radiation is placed in the same room as the wireless microphone 2 and the speaker apparatus 3.

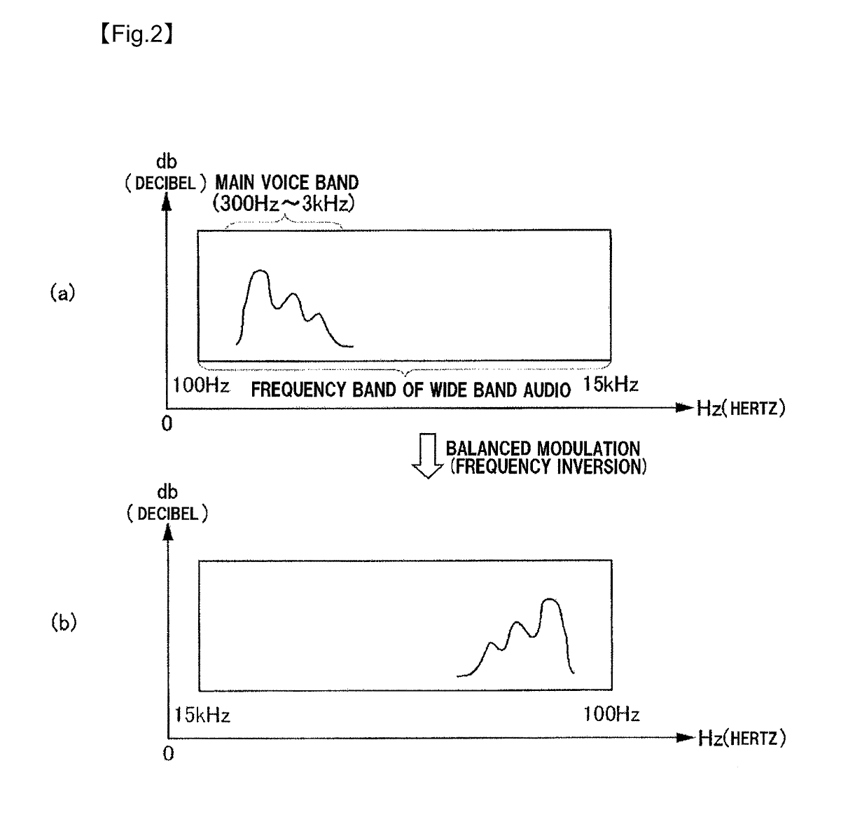

FIG. 2 includes diagrams for illustrating an operation of the wireless microphone 2 according to this embodiment. As shown in FIG. 2, when an audio signal in a wide band including the voice band (100 Hz to 3 kHz) is input to the microphone 4 (see FIG. 2(a)), the wireless microphone 2 according to this embodiment performs the balanced modulation processing to invert the frequency spectrum of the audio signal (see FIG. 2(b)). Then, the balanced-modulated audio signal is transmitted from the wireless microphone 2. At this time, if the noise detecting portion 14 in the wireless microphone 2 determines that there is infrared radiation noise produced by the external apparatus based on the detection result from the infrared radiation detecting sensor 12 or the user input described above, the noise detection signal is superimposed on the audio signal to be transmitted from the wireless microphone 2.

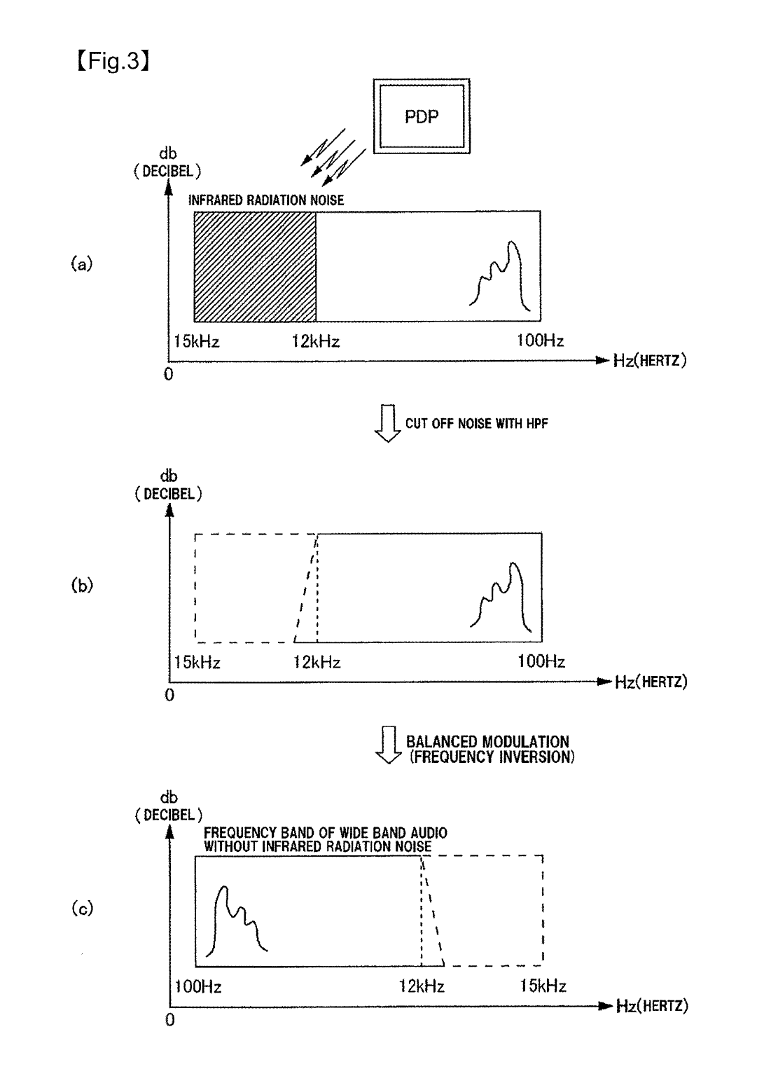

FIG. 3 includes diagrams for illustrating an operation of the speaker apparatus 3 according to this embodiment. As shown in FIG. 3, the speaker apparatus 3 according to this embodiment receives the audio signal transmitted from the wireless microphone 2, and the audio signal will include infrared radiation noise produced by the external apparatus (such as a PDP) (see FIG. 3(a)). In this case, the speaker apparatus 3 turns on the high-pass filter 18 based on the noise detection signal extracted from the audio signal to cut off the components of the received audio signal at frequencies equal to or lower than the predetermined cut-off frequency (3 kHz, for example) (that is, the components including the infrared radiation noise) (see FIG. 3(b)). Then, the balanced modulation processing of inverting (again) the frequency spectrum of the audio signal (reverse balanced modulation processing) is performed (see FIG. 3(c)), and the processed audio signal is output as sound from the speaker 23.

The communication system 1 that transmits and receives an audio signal in a wide band according to the first embodiment of the present invention described above can appropriately remove the infrared radiation noise from the external apparatus.

Specifically, according to this embodiment, the wireless microphone 2 performs the balanced modulation processing to invert the frequency spectrum of the audio signal in the wide band and transmits the balanced-modulated (frequency-inverted) audio signal. The speaker apparatus 3 cuts off the signal in the frequency band of the infrared radiation noise produced by the external apparatus (infrared radiation noise band), performs the reverse balanced modulation processing to invert again the frequency spectrum of the audio signal and outputs the processed audio signal. Thus, even if there is intense infrared radiation noise produced by the external apparatus (such as a PDP), the signal in the frequency band of the noise (infrared radiation noise band) is cut off, thereby removing or substantially reducing the infrared radiation noise. Therefore, the speaker apparatus 3 can output an audio signal with no or extremely low noise.

### Second Embodiment

Next, a communication system 1 according to a second embodiment of the present invention will be described. The following description of the communication system 1 according to the second embodiment will be focused mainly on differences from the first embodiment. The configuration and operation of the communication system 1 according to this embodiment is the same as the first embodiment unless otherwise described.

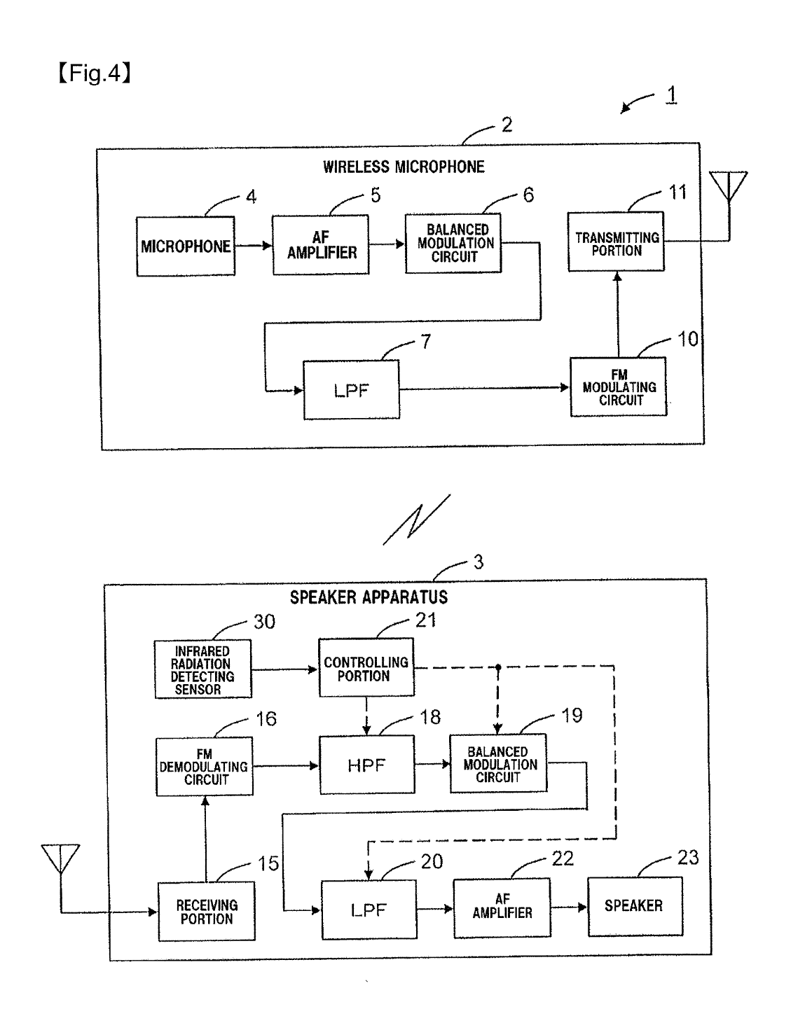

FIG. 4 is a block diagram showing a configuration of the communication system 1 according to this embodiment of the present invention. As shown in FIG. 4, a wireless microphone 2 according to this embodiment does not include the arrangement for detecting infrared radiation (the controlling portion 8, the signal superimposing portion 9, the infrared radiation detecting sensor 12, the user input receiving portion 13 and the noise detecting portion 14) according to the first embodiment. Accordingly, a speaker apparatus 3 according to this embodiment does not include the signal extracting portion 17 according to the first embodiment. Instead, the speaker apparatus 3 according to this embodiment includes an infrared radiation detecting sensor 30 that detects infrared radiation from an external apparatus such as a plasma display panel (PDP).

An operation of the communication system 1 configured as described above will be described. According to this embodiment, the wireless microphone 2 does not perform detection of infrared radiation but merely transmits a balanced-modulated audio signal. On the other hand, the speaker apparatus 3 controls the operation (switching on/off) of a high-pass filter 18 based on the detection result from the infrared radiation detecting sensor 30. More specifically, for example, when the level of the infrared radiation detected by the infrared radiation detecting sensor 30 is equal to or higher than a predetermined threshold, a controlling portion 21 controls the high-pass filter 18 to cut off components at frequencies equal to or lower than a predetermined frequency (3 kHz, for example).

When there is no infrared radiation noise, the controlling portion 21 keeps the high-pass filter 18 inactive to allow the audio signal pass through the high-pass filter 18 or sets the high-pass filter 18 to operate with a low cut-off frequency such as 50 to 100 Hz. In this way, when the infrared radiation detecting sensor 30 detects infrared radiation, the high-pass filter 18 is activated to remove the infrared radiation noise before the sound is reproduced, and when the infrared radiation detecting sensor 30 detects no infrared radiation, the sound over the entire audio band with high quality can be reproduced. Although the predetermined frequency (cut-off frequency of the high-pass filter 18) is 3 kHz in the example described above, the cut-off frequency of the high-pass filter 18 is, of course, not limited to the value.

The communication system 1 according to the second embodiment of the present invention described above has the same effects and advantages as the communication system according to the first embodiment.

In addition, according to this embodiment, whether or not there is infrared radiation noise from the external apparatus (such as PDP) can be automatically properly determined on the side of the speaker apparatus based on the infrared radiation detection result from the infrared radiation detecting sensor 30 disposed in the speaker apparatus 3.

Although currently possible preferred embodiments of the present invention have been described above, many modifications can be made to those embodiments without departing from the true spirit and scope of the present invention, and all those modifications fall within the scope of the accompanying claims.

### REFERENCE SIGNS LIST

1 Communication system
2 Wireless microphone
3 Speaker apparatus
4 Microphone
5 AF amplifier
6 Balanced modulation circuit
7 Low-pass filter
8 Controlling portion
9 Signal superimposing portion
10 FM modulating circuit
11 Transmitting portion
12 Infrared radiation detecting sensor
13 User input receiving portion
14 Noise detecting portion
15 Receiving portion
16 FM demodulating circuit
17 Signal extracting portion
18 High-pass filter
19 Balanced modulation circuit
20 Low-pass filter
21 Controlling portion
22 AF amplifier
23 Speaker
30 Infrared radiation detecting sensor

1. A communication system, comprising:
a transmitting apparatus that transmits an audio signal in a wide band including a frequency band higher than a voice band; and
a receiving apparatus that receives the audio signal from said transmitting apparatus,
wherein said transmitting apparatus comprises:
an audio input portion to which said audio signal in the wide band is input;
a balanced modulation portion that inverts a frequency spectrum of the audio signal input to said audio input portion; and
a transmitting portion that transmits the audio signal having the frequency spectrum inverted by said balanced modulation portion, and
said receiving apparatus comprises:
a receiving portion that receives the audio signal transmitted from said transmitting apparatus;
a filter portion that cuts off a frequency component in a frequency band of infrared radiation noise of the audio signal received by said receiving portion;
a reverse balanced modulation portion that inverts again the frequency spectrum of the audio signal having the frequency component in the frequency band of the infrared radiation noise cut off by said filter portion; and
an audio output portion that outputs the audio signal having the frequency spectrum inverted again by said reverse balanced modulation portion.

2. The communication system according to claim 1, wherein said transmitting apparatus further comprises:
a first infrared radiation noise detecting portion that detects infrared radiation noise equal to or higher than a predetermined threshold in a vicinity of said transmitting apparatus; and
a balanced modulation controlling portion that controls said balanced modulation portion to invert the frequency spectrum of said audio signal in a case where said first infrared radiation noise detecting portion detects the infrared radiation noise equal to or higher than said predetermined threshold, and
said receiving apparatus further comprises:
a filter controlling portion that, in the case where said first infrared radiation noise detecting portion detects said infrared radiation noise, controls said filter portion to cut off a frequency component in the frequency band of said infrared radiation noise; and
a reverse balanced modulation controlling portion that, in the case where said first infrared radiation noise detecting portion detects said infrared radiation noise, controls said reverse balanced modulation portion to invert again the frequency spectrum of the audio signal having the frequency component in the frequency band of said infrared radiation noise cut off by said filter portion.

3. The communication system according to claim 2, wherein said transmitting apparatus further comprises:
a signal superimposing portion that, in the case where said first infrared radiation noise detecting portion detects said infrared radiation noise, superimposes a noise detection signal that indicates occurrence of said infrared radiation noise on the audio signal to be transmitted from said transmitting portion,
said receiving apparatus further comprises:
a signal extracting portion that extracts said noise detection signal from the audio signal received at said receiving portion, and
in a case where said signal extracting portion detects said noise detection signal, said filter controlling portion activates said filter portion, and said reverse balanced modulation controlling portion activates said reverse balanced modulation portion.

4. The communication system according to claim 3, wherein said noise detection signal superimposed on said audio signal includes a predetermined tone signal, and
in a case where said signal extracting portion extracts said tone signal included in said noise detection signal from the audio signal received at said receiving portion, said filter controlling portion activates said filter portion, and said reverse balanced modulation controlling portion activates said reverse balanced modulation portion.

5. The communication system according to claim 1, wherein said receiving apparatus further comprises:
a second infrared radiation noise detecting portion that detects infrared radiation noise equal to or higher than a predetermined threshold in a vicinity of said receiving apparatus;
a filter controlling portion that, in a case where said second infrared radiation noise detecting portion detects said infrared radiation noise, controls said filter portion to cut off a frequency component in the frequency band of said infrared radiation noise; and
a reverse balanced modulation controlling portion that, in the case where said second infrared radiation noise detecting portion detects said infrared radiation noise, controls said reverse balanced modulation portion to invert again the frequency spectrum of the audio signal having the frequency component in the frequency band of said infrared radiation noise cut off by said filter portion.

6. A receiving apparatus that receives an audio signal in a wide band including a frequency band higher than a voice band, comprising:
a receiving portion that receives said audio signal;
a filter portion that cuts off a frequency component in a frequency band of infrared radiation noise of the audio signal received by said receiving portion;
a reverse balanced modulation portion that inverts again a frequency spectrum of the audio signal having the frequency component in the frequency band of said infrared radiation noise cut off by said filter portion; and
an audio output portion that outputs the audio signal having said frequency spectrum inverted again by said reverse balanced modulation portion.

7. A communication method performed in a communication system comprising a transmitting apparatus that transmits an audio signal in a wide band including a frequency band higher than a voice band and a receiving apparatus that receives the audio signal from said transmitting apparatus, the method comprising the steps of:
said transmitting apparatus
inverting a frequency spectrum of the input audio signal; and
transmitting the audio signal having the frequency spectrum inverted to said receiving apparatus; and
said receiving apparatus
receiving the audio signal transmitted from said transmitting apparatus;
cutting off a frequency component in a frequency band of infrared radiation noise of the received audio signal;
inverting again the frequency spectrum of the audio signal having the frequency component in the frequency band of said infrared radiation noise cut off; and
outputting the audio signal having the frequency spectrum inverted again.
